(19) United States
(12) Patent Application Publication
(10) Pub. No.: US 2008/0289015 A1
(43) Pub. Date: Nov. 20, 2008

(54) Resetting of Security Mechanisms

(76) Inventor: Heribert Hartlage, Munchen (DE)

Correspondence Address: Siemen Corporation;Intellectual Property Department, 170 Wood Avenue South, Iselin, NY, 08830, US

(21) Appl. No.: 11/658,293

(22) PCT Filed: Jul. 18, 2005
(86) PCT No.: PCT/EP2005/053462

§ 371 Date: Jan. 23, 2007

(30) Foreign Application Priority Data
Jul. 23, 2004 (EP) 04017538.2

(51) Int. Cl. H04L 9/32

(52) U.S. Cl. 726/7; 726/28

(57) ABSTRACT

The security mechanism of a product is realized in such a manner that the data, which is assigned thereto, cannot, in contrast to the remaining data of the product, be accessed from outside the product. The resetting is effected by deleting the data following an intervention from inside the product. The data D_{SM} and D_{CM} are preferably stored on different modules so that the security mechanism can be operated without loss of data by pulling the module on which the data are stored. As a result, transmission processes existing in a product provided in the form of a network element of a communications network are unaffected by the resetting.

### CROSS REFERENCE TO RELATED APPLICATIONS

This application is the US National Stage of International Application No. PCT/EP2005/053462, filed Jul. 18, 2005 and claims the benefit thereof. The International Application claims the benefits of European application No. 04017538.2 EP filed Jul. 23, 2004, both of the applications are incorporated by reference herein in their entirety.

### FIELD OF INVENTION

The present invention relates to a resetting of security mechanisms.

### BACKGROUND OF INVENTION

A reference architecture of a Telecommunications Management Network (TMN) for monitoring and controlling a network for telecommunications applications is described in the ITU-T's international M.3010 standard (02/2000), the basis of said architecture being that the network controlled by the TMN includes different types of network elements customarily controlled with the aid of different communication mechanisms (which is to say protocols, reports, and management information—referred to also as an object model).

Said TMN includes the following functionalities:
Operations Systems Function (OSF), which realizes the “actual” management of the telecommunication network.
Workstation Function (WSF), which serves to present the control processes and network status for a human TMN user.
Network Element Function (NEF), which provides an interface for controlling the network elements' telecommunication functions. Said interface defines the specific communication mechanism of the respective network element, which mechanism may not have been standardized. The sum of all the NE's management information is referred to as the NE's Management Information Base (MIB). Below it is also called NE-MIB.
Transformation Function (TF), which is used for connecting components to different communication mechanisms and, in particular, for linking network elements not having a standardized NEF to the TMN. In the M.3010 standard (05/96) it is referred to also as the Mediation Function or Q-Adaptation Function.

Said functionalities are furthermore classified, where possible, into the following groups according to the FCAPS scheme:

### F=Fault

### C=Configuration

### A=Accounting

### P=Performance

### S=Security

The functions are realized by means of material products that can be embodied as, for example, a network element (NE), operations system (OS), application, terminal, router, switch, database server, or computer-program product, but are not, of course, restricted thereto.

The NEF function is customarily assigned to an NE, while the OSF and WSF functions are usually assigned to an OS. An OS is customarily assigned a multiplicity of NEs, with the OS usually being centralized while the NEs are distributed in the network on a non-centralized basis over a multiplicity of locations.

A Data Communication Network (DCN) for conveying information can be provided between the NE and OS. Information is conveyed according to the principles of the transport service as described in the lower layers of the ISO/OSI reference model in the international X.200 standard.

An OS can contain a plurality of programs, also called applications or software. Said programs can be embodied as, for example, management applications for controlling different network technologies of a communication network, by which applications in each case one application-specific subset, relevant to the respectively controlled technology, of the network's resources is modeled, visualized, and controlled.

The programs are executed by hardware (for example a processor or i/o module) provided in the devices. Their execution is supported by support software (for example a multitasking or, as the case may be, multithreading operating system, database system, or Windows system).

The security functionality is realized within the products using, for instance, security mechanisms in the case of which secured access to the products is enabled by means of access authorizations—by way of, for example, a user identification (userId) and password and/or presentation of a security certificate.

### SUMMARY OF INVENTION

In modern systems, the security mechanisms present in the OS and NEs customarily have a basic state. For example they are non-activated or have a default userId and a default password for accessing the products for the first time, for instance in the factory or on the customer's premises on startup. When the products have been accessed for the first time, further userIDs with associated passwords can be created by appropriately privileged users—also called security administrators—of the products. The default password is, moreover, usually changed when that is done.

It is clear from what has been explained hitherto that rendering the described architecture into specific solutions poses highly complex technical problems owing to the system's distinct distributed nature and the multiplicity of different system components and requirements.

An object of the invention is to acknowledge at least one of the present problems and resolve it by disclosing at least one course of technical action.

The invention is based on the following understandings:
If an access authorization is lost, its (former) user will no longer have access to the system secured thereby. It will no longer be possible to access the system at all if all access authorizations have been lost. Access to the system will in that case usually be restored with the aid of a special procedure. The same may also be necessary if the security administrator's access authorization has been lost. That will be the case if, say, a particularly important password has been lost, such as that of the security administrator (what is under Unix termed the “root” user's password, for example), as it will not then be possible to administer the NE in an expedient manner. A similar situation will prevail if the certificate for the security administrator has expired and is no longer accepted by the NE. It will as a consequence of said loss initially no longer be possible to administer the affected NE completely. That can result over time in the network element's no longer being controllable at all because, for example, operator IDs are blocked automatically owing to a longer period of non-use and will have to be enabled by the security administrator who, though, is likewise of no further help. Costs will consequently be incurred by the network operator and possibly also by the manufacturer. There must for that reason be a controlled method allowing the network element to be completely controlled again.
Telecommunication operators' requirements placed on network elements in terms of controlled access by means of security mechanisms requiring user identification and a password or user certificate are increasing. The requirement for a user not to have any possibility of bypassing said security mechanisms is consequently also increasing.
Conversely, there is the requirement for the security mechanism(s) to be able to be reset if certain or all access authorizations have been lost.
The known techniques for resetting security mechanisms have undesirable side-effects and, in particular, too greatly contravene the requirement for a user not to have any possibility of bypassing said security mechanisms:
One technique provides for re-enabling access when, say, the security administrator's password has been lost by replacing the contents of the network elements' internal database with a backup containing a known password. When the contents of the database are replaced by a backup, it is usual for obsolete configuration data contained in the backup also to be loaded onto the NE and for the NE to be put into operation again using obsolete data. This also entails the risk that traffic will be rejected owing to the obsolete data.
Another technique provides for erasing the NE's internal database by removing and re-plugging what is termed the database card and by removing and re-plugging the main control board. A condition akin to that of an initial installation will then be achieved when the database card is removed and re-plugged. All previously created configuration data will likewise have been erased as it is located in the same database as the access authorizations. The NE will have to be tediously re-configured; existing traffic will be interrupted.

A solution to said inventively acknowledged problematic situation as well as advantageous embodiments of said solution are disclosed in the claims.

### BRIEF DESCRIPTION OF THE DRAWING

The invention is explained below with the aid of exemplary embodiments that are also shown in the figures. It is stressed that, despite their in part very accurate presentation, the illustrated embodiments of the invention are purely exemplary in nature and not to be understood as being limiting.

FIG. 1 shows an exemplary arrangement comprising a central operations system OS having applications A for controlling non-centralized elements NE of a communication network KN.

### DETAILED DESCRIPTION OF INVENTION

As a solution to the conflict between the security mechanisms' requiring to be incapable of being bypassed and their requiring to be capable of being reset, it is proposed that the requirement for the security mechanisms to be incapable of being bypassed be contravened as little as possible. That is done by fulfilling the following criteria at least partially:
1. The security mechanisms are only allowed to be taken out of operation locally (with physical contact with the NE).
2. Taking the security mechanisms out of operation requires a temporal, which is to say at least brief, change to the hardware configuration (for example removing and re-plugging modules).

Further conditions also need to have been met that make use by an unauthorized attacker difficult following the resetting operation:
3. The database for the NE's main board is erased.

To minimize the detrimental impact for the operator, the following condition should also have been met:
4. No traffic must be rejected by the NE while these actions are being performed.

To at least partially fulfill said criteria, the configuration data assigned to the security mechanisms is stored separately from the other data in such a way that the configuration and measurement data not assigned to the security mechanisms can be retained unchanged, while the data assigned to the security mechanisms will be reset.

That will also be necessary if the passwords are such that are not allowed to be read from the NE. This constraint on reading will apply also if passwords are stored permanently and it is possible to upload the NE's internal data. In that case the memory areas in which the configuration data and other data of security mechanisms are permanently stored must not be capable of being uploaded as part of a data backup operation.

In an embodiment of the invention where the physically separately stored data is stored on the same module, the configuration and measurement data not assigned to the security mechanisms can therefore be written back to the NE's permanent internal database with no changes being made the stored configuration data for security mechanisms. If the configuration and measurement data not assigned to the security mechanisms is therein regularly backed up, the most up-to-date data can be written back to the NE when the security mechanisms have been reset and the NE's control unit can resume its service without interruption to the telecommunication traffic.

Particularly attractive advantages are associated with an embodiment in which the configuration data assigned to the security mechanisms is permanently stored physically separately on a special module, for example, and said module can be replaced by another containing the configuration data for the security mechanisms in the basic state. Uploading of the configuration and measurement data assigned to the security mechanisms will in that case be omitted. In that case it will only be necessary to re-configure the security mechanisms; the telecommunication traffic will remain unaffected thereby. Access to a network element, and hence to the modules, being as a general rule secured by lock and key, adequate security will also be insured thereby.

When the security mechanisms have been taken out of and returned to operation, the NE will in terms of said mechanisms be in a state corresponding to initial startup. Depending on the security mechanisms' basic state, these are either non-activated or a default userId and default password are available for the security administrator.

The other configuration and measurement data not assigned to the security mechanisms can, after these measures, be made available again unchanged. Interruption of the telecommunication traffic will be avoided.

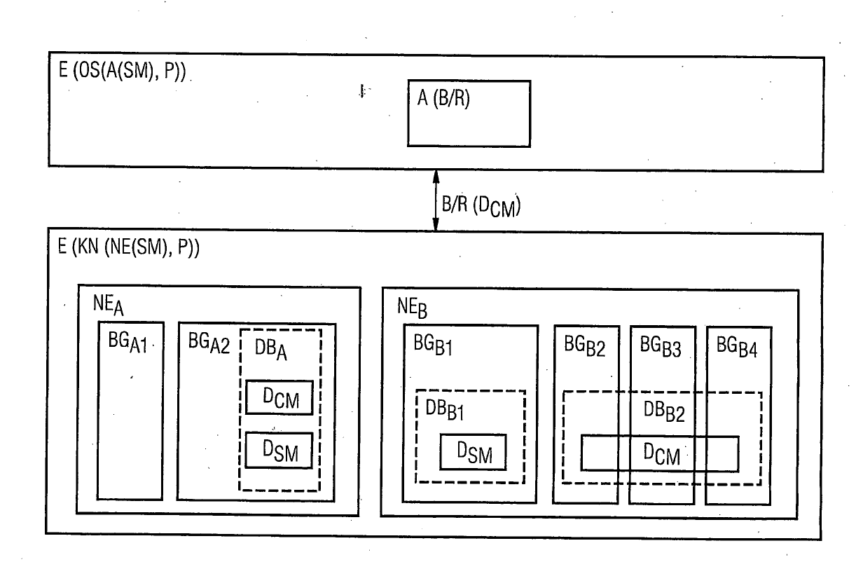

The embodiment of the invention will be explained below aided also by the arrangement shown in FIG. 1 containing a multiplicity of material products E arranged in a distributed manner. The products E are embodied as, for example, network elements NE_{A}, NE_{B}, arranged non-centrally in a distributed manner, of a communication network KN, or as a central operations system OS having applications A for controlling the non-centralized elements NE of the communication network KN. The products have security mechanisms SM for preventing unauthorized use of the products because said products E are not allowed to be controlled unrestrictedly by just anyone. The applications A are embodied as, for example, an application B/R for backing up and restoring configuration and measurement data D_{SM} of network elements NE, which data is not assigned to the security mechanisms SM. Also stored in the network elements NE is configuration data D_{SM} assigned to the security mechanisms SM that is embodied as, for example, userId/password pairs or as security certificates. The data D_{SM} is inaccessible to the application B/R and cannot be conveyed to the operations system OS.

The products E include hardware, in particular processors and storage means, with whose aid in particular the products E embodied as a computer-program product P or, as the case may be, a program P are executed. The hardware can also correspond directly to the products E in the form of, for example an Application Specific Integrated Circuit (ASIC) or equivalent material product E.

The products embodied as applications A can be assigned the TMN function blocks Operations Systems Function (OSF) and Workstation Function (WSF); the products embodied as network elements NE can be assigned the TMN function block Network Element Function (NEF).

The operations system OS and network elements NE are connected by what is referred to technically as a Data Communication Network (DCN) via which the data D_{SM} is conveyed by the application B/R during backup/restore.

The network elements NE each include at least one module BG. The data D_{SM} and D_{SM} are stored separately from each other in the two network elements NE. They are, moreover, permanently stored physically separately in the network element NE_{B}.

Although located on the same module BG_{A2} in the network element NE_{A}, and even in the same database DB_{A}, the data D_{SM} and D_{CM} are stored there separately in different memory areas in such a way that only the data D_{CM} and not the data D_{SM} is externally accessible and, for example, can be conveyed via the DCN to the operations systems OS and vice versa.

When the security mechanism SM of the network element NE_{A} is reset, preferably the data D_{CM} is loaded first into the operations system OS by the application B/R. The module BG_{A2} is then removed until the database DB_{A}, and consequently the data D_{CM} and D_{SM}, has been erased in the network element NE_{A}. The security mechanism SM of the network element NE_{A} is in its basic state again when the data D_{SM} has been erased and is either deactivated or again has the original default userId and original default password for the security administrator. The data D_{CM} is then re-loaded into the network element NE_{A} with the aid of the application B/R so that said element is again fully operable and its security settings can be configured again.

The data D_{SM} and D_{CM} are permanently stored physically separately on different modules BG_{B} in the network element NE_{B}. The data D_{SM} is located on the module BG_{B1} in the database DB_{B1}. The data D_{CM} is located in the database DB_{B2} that is distributed over the modules BG_{B2-4}. The network element NE_{B} is set up in such a way that only the data D_{CM} and not the data D_{SM} is externally accessible and, for example, can be conveyed via the DCN to the operations systems OS and vice versa.

It is not necessary for the data D_{CM} to be backed up by the application B/R into the operations system OS when the security mechanism SM of the network element NE_{B} is reset. The module BG_{B1} can, thanks to the physically separate storage, be immediately removed until the database DB_{B}, and consequently the data D_{SM}, has been erased in the network element NE_{A}. The security mechanism SM of the network element NE_{B} is in its basic state again when the data D_{SM} has been erased and is either deactivated or again has the original default userId and original default password for the security administrator. The data D_{CM} is fully retained in the network element NE_{B} during said resetting operation so that said element remains permanently fully operable even while the security mechanism SM is being reset.

A multiplicity of advantages are associated with the invention:
Penetration of the product, especially unauthorized external manipulating of the security mechanism in particular from the operations systems OS or via the Data Communication Network, which could also include, inter alia, the internet, is effectively prevented owing to intervention from within the product.
Owing to the physical separation, the other configuration and measurement data will remain unchanged while the security mechanisms are being reset.
A user who does not have physical access to the NE cannot bypass active security mechanisms.
Access to the network element can by using a lock and key be very easily restricted to a selected group of persons who can then perform the resetting of security mechanisms.
The costs resulting from an NE's inoperability will be minimized. There will be economic advantages for a network operator due to a reduction in OPEX (OPerational EXpenses).
The invention's implementation does not require any fundamental changes to the prior art but can basically be realized subsequently in the form of a component, in particular a modified or additional computer-program product.
The time of implementation is not dependent on the time at which other functions are realized.
It is insured by means of the invention that the individual components of the system as a whole will be subjected to only a low level of loading and hence the stability of the system as a whole will be increased.

In conclusion, attention is drawn to the fact that the description of the system's components relevant to the invention is basically not to be understood as being limiting in terms of any specific physical realization or assignment. It will in particular be obvious to a person skilled in the relevant art that the invention can be realized partially or entirely in the form of software and in a manner distributed over a plurality of material products/computer-program products.

1-10. (canceled)

11. A method for a security mechanism of a network element, comprising:
providing a first data assigned to the security mechanism,
wherein the first data is not accessible from outside of the element, and
wherein the security mechanism provides access to the network element by an authorized user via the first data;
providing a second data assigned to functions other than the security mechanism;
erasing the first data; and
resetting the security mechanism as a result of erasing the first data.

12. The method as claimed in claim 11, wherein the first data includes a user identifier and a password.

13. The method as claimed in claim 11,
wherein the network element handles traffic in a communication network, and
wherein the traffic is not rejected during the erasing or the resetting.

14. The method as claimed in claim 11, wherein the first data is erased by removing a first module of the network element.

15. The method as claimed in claim 14, wherein the first module is a hardware module.

16. The method as claimed in claim 15, wherein the first data is set to a known value as a result to resetting the security mechanism.

17. The method as claimed in claim 15, wherein the resetting the security mechanism is a result of inserting the removed module.

18. The method as claimed in claim 15, wherein the first data is stored on the first module and the second data is stored on a second module, the first module is a physically separate hardware module than the second module.

19. The method as claimed in claim 15, wherein the first module is mechanically secured against unauthorized removal.

20. The method as claimed in claim 15, wherein the second data is buffered outside the network element prior to the erasing.

21. A network element device having a security mechanism, comprising:
a first data assigned to the security mechanism,
wherein the first data is not accessible from outside of the element, and
wherein the first data includes a user identification and password,
a second data assigned to functions other than the security mechanism;
a first hardware module comprising the first data,
wherein the first data is erased by unplugging the first hardware module from the device, and
wherein the security mechanism is reset as a result of plugging in a second hardware module into the device,
whereby the second data is maintained.

22. The device as claimed in claim 21, wherein the second hardware module is the same as the first hardware module.

23. The device as claimed in claim 21,
wherein the network element handles traffic in a network, and
wherein the traffic is not rejected during the erasing or the resetting.

24. The device as claimed in claim 21, wherein the first data is set to a known value as a result to resetting the security mechanism.

25. The device as claimed in claim 21, further comprises a third hardware module comprising the second data, wherein the third hardware module is a physically separate hardware module than the first module such that the second data is maintained when the first hardware module is unplugged.

26. The device as claimed in claim 21, the first module is mechanically secured against unauthorized removal.

27. The device as claimed in claim 21,
wherein the second data is buffered outside the network element prior to the erasing, and
wherein the second data is restored after the erasing such that the second data is maintained.
